(19) United States
(12) Patent Application Publication
(10) Pub. No.: US 2015/0216205 A1
(43) Pub. Date: Aug. 6, 2015

(54) PET FOOD

(71) Applicant: Unicharm Corporation `, Ehime (JP)

(72) Inventor: Yuma Ikezaki, Itami-shi (JP)

(21) Appl. No.: 14/422,178

(22) PCT Filed: Aug. 30, 2013
(86) PCT No.: PCT/JP2013/074004

§ 371 Date: Feb. 17, 2015

(30) Foreign Application Priority Data
Aug. 31, 2012 (JP) 2012-191487
Sep. 28, 2012 (JP) 2012-218553

(51) Int. Cl. A23K 1/10; A23K 1/18

(52) U.S. Cl. CPC A23K 1/103; A23K 1/1866

(57) ABSTRACT

The present description relates to a pet food having a consistency measured using a Bostwick consistometer of 9.0 to 16.0 cm/minute, and having a water content of at least 80.0% by weight of the total weight of the pet food composition with an opening size.

### TECHNICAL FIELD

The present invention relates to a pet food. More specifically, the invention relates to a pet food having improved palatability for pets.

Priority is claimed from Japanese Patent Application No. 2012-191487, filed Aug. 31, 2012, and Japanese Patent Application No. 2012-218553, filed Sep. 28, 2012, the contents of which are incorporated herein by reference.

### BACKGROUND

In order to provide a comprehensive nutritional diet for pets, a method of manufacturing a pet food with improved palatability by granulating a pet food composition containing a blend of nutritionally-balanced ingredients, heating the granules to alphatize the starch component and dry the granules, and then subjecting the granules to a frying treatment in oil at a temperature of not more than 180° C. has already been disclosed (Patent Document 1). Further, a method of manufacturing a pet food in which a granulated pet food is molded into a flat plate shape using an extruder has also been disclosed (Patent Document 2). Presently, pet food is commonly prepared and sold in a solid jelly-type form, particularly pet food for cats.

### DOCUMENTS

### Patent Documents

[Patent Document 1] Japanese Unexamined Patent Application, First Publication No. Sho 64-39953

[Patent Document 2] Japanese Patent (Granted) Publication No. 3,793,845

### SUMMARY

### Problems Solveable

Conventional techniques for altering the taste of pet food by performing the type of oil frying treatment described in Patent Document 1, or creatively altering the shape of pet food granules as disclosed in Patent Document 2 are already known. However, frying treatments have a problem in that the calorific content of the pet food increases, whereas if the shape of the granules is altered, then a problem arises in that a portion of the food may remain uneaten.

In recent years, health awareness for pet food has also increased, and pet foods that are good for the health of the pet, as well as having excellent palatability are very desirable. Further, maintaining good health for the pet, while also ensuring satisfactory intake of nutrition and water by the pet is also desirable.

The present description has been developed in light of the above circumstances, and has potential of providing a highly palatable pet food that is formulated using a blend of ingredients having good nutritional balance with the health of the pet in mind

### Means Sufficient To Solve Problems

The present description relates to the following.
(1) A pet food, having a consistency measured using a Bostwick consistometer of 9.0 to 16.0 cm/minute, and having a water content of at least 80.0% by weight of the total weight of the pet food composition.
(2) The pet food disclosed above in (1), wherein the solid component fill weight is within a range from 10.5 to 14.0% by weight of the total weight of the pet food composition.
(3) The pet food disclosed above in (1) or (2), wherein the consistency is from 14.5 to 15.5 cm/minute, and the solid component fill weight is from 11.0 to 13.0% by weight of the total weight of the pet food composition.
(4) A pet food containing solid ingredients not passing through a sieve with an opening size of 710 μm, and having a water content of at least 80.0% by weight of the total weight of the pet food composition.
In another aspect of (4), a pet food containing solid ingredients not passing through a sieve with an opening size of 710 μm, having a water content of at least 80.0% by weight of the total weight of the pet food composition, and having fluidity.
(5) The pet food disclosed above in (4), wherein the solid ingredients have sizes passing through a sieve with an opening size of 10 mm.
(6) The pet food disclosed above in (4) or (5), wherein a content of the solid ingredients is at least 12.0% by weight of the total weight of the pet food composition.
(7) The pet food disclosed above in any one of (4) to (6), having a consistency measured using a Bostwick consistometer of 14.5 to 15.5 cm/minute, wherein a content of the solid ingredients is within a range from 12.0 to 20.0% by weight of the total weight of the pet food composition.
(8) The pet food disclosed above in any one of (4) to (6), having a consistency measured using a Bostwick consistometer of 11.0 to 12.0 cm/minute, wherein a content of the solid ingredients is within a range from 13.0 to 19.0% by weight of the total weight of the pet food composition.
(9) The pet food disclosed above in any one of (4) to (6), having a consistency measured using a Bostwick consistometer of 9.0 to 9.5 cm/minute, wherein a content of the solid ingredients is within a range from 21.0 to 23.0% by weight.
(10) The pet food disclosed above in any one of (4) to (9), wherein the solid component fill weight is within a range from 10.5 to 14.0% by weight.
(11) The pet food disclosed above in any one of (4) to (7), having a consistency measured using a Bostwick consistometer of 14.5 to 15.5 cm/minute, wherein the solid component fill weight is within a range from 10.8 to 13.0% by weight.
(12) The pet food disclosed above in (1) or (2), or in any one of (4) to (6), or in (8), wherein the consistency is from 11.0 to 12.0 cm/minute, and the solid component fill weight is from 12.0 to 14.0% by weight.
(13) The pet food disclosed above in any one of (1) to (12), further containing a thickener.
(14) The pet food disclosed above in any one of (1) to (13), wherein the pet food is in a paste form.
(15) The pet food disclosed above in any one of (4) to (14), wherein at least 50% by weight of solid ingredients are derived from fish.
(16) The pet food disclosed above in any one of (1) to (15), wherein at least 50% by weight of the solid component is derived from fish.
(17) The pet food disclosed above in (13), wherein the thickener is guar gum.
(18) The pet food disclosed above in any one of (1) to (17), wherein the pet food is a food for cats.
(19) The pet food disclosed above in any one of (1) to (18), wherein the pet food is packed inside a pouch container.

Another aspect of the present description relates to the following.
(101) A pet food composition containing protein components and water.
(102) The pet food composition disclosed above in (101), having a consistency measured using a Bostwick consistometer of 9.0 to 16.0 cm/minute, and having a water content of at least 80.0% by weight of the total weight of the pet food composition.
(103) The pet food composition disclosed above in (101) or (102), containing solid ingredients not passing through a sieve with an opening size of 710 μm, and having a water content of at least 80.0% by weight of the total weight of the pet food composition.
(104) The pet food composition disclosed above in any one of (101) to (103), further containing a thickener.
(105) The pet food composition disclosed above in any one of (101) to (104), wherein the protein components are fish-derived components.
(106) A method of manufacturing a pet food, including mixing the pet food composition disclosed above in any one of (101) to (105), treating the pet food composition by employing a mincer, and treating the pet food composition by employing a mixer.
(107) A method of feeding a pet a sufficient amount of a pet food of (101) to (105) to provide sustenance to the pet for a period of one meal.

### Effects Acheivable

According to the pet food of the present description, because a nutritionally balanced material is altered to a readily edible state, the palatability by pets improves. Further, because the pet food ingredients include a considerable amount of water, the pet can ingest water together with the pet food, which contributes to maintenance of the health of the pet.

### BRIEF DESCRIPTION OF THE DRAWINGS

FIG. 1A is a schematic perspective view of a Bostwick consistometer.

FIG. 1B is a schematic perspective view of a Bostwick consistometer.

### EMBODIMENTS

### <<Pet Food>>

### First Embodiment

A pet food according to a first embodiment has a consistency measured using a Bostwick consistometer of 9.0 to 16.0 cm/minute, and has a water content of at least 80.0% by weight of the total weight of the pet food composition.

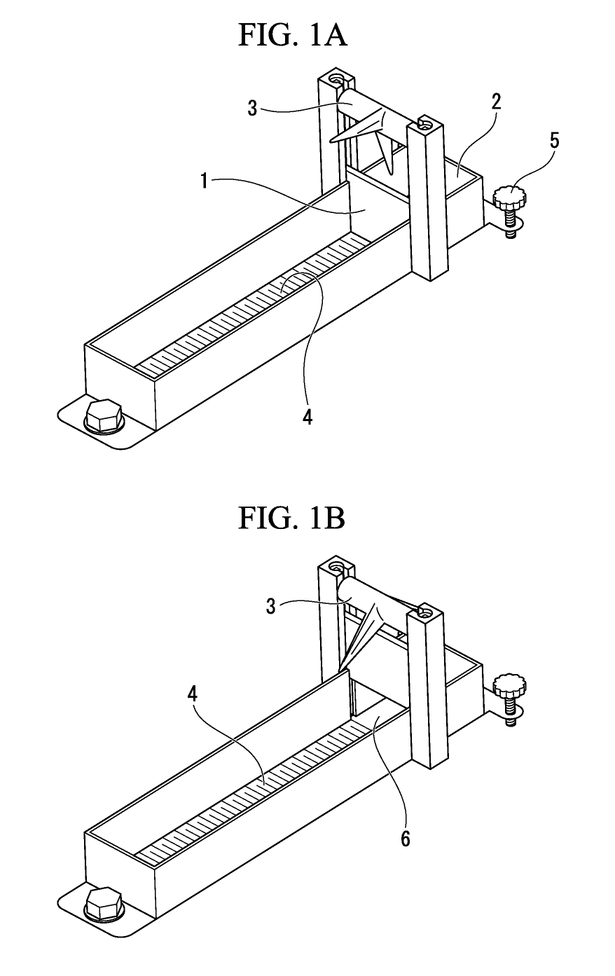

A Bostwick consistometer is well known in the food industry as a device for measuring the consistency of foods. Outlines of the consistometer are illustrated in FIG. 1A and FIG. 1B. The measurement method is as follows. First, in a state where a gate 1 is lowered (FIG. 1A), a specified amount of a sample is poured into an upstream section 2. Next, a lever 3 is rotated to raise the gate 1, and time measurement is commenced at the same time. By raising the gate 1, the sample 2 flows from the upstream section 2, through an opening 6 and toward a downstream section 4 (FIG. 1B). After a specified time has elapsed, the distance that the leading edge of the flowing sample has reached is measured.

In the present description, the reported values were measured under the following conditions.

The consistometer was installed on a horizontal mount, and a height adjustment screw 5 was adjusted so that the downstream section 4 that functions as a slide was set to an inclination of one degree relative to the horizontal. The width of the downstream section 4 and the upstream section was 5 cm. Measurement was performed under conditions including a sample temperature of 25° C. and a room temperature of 25° C. A volume of 92.5 ml of the sample was poured into the upstream section 2, and the distance that the leading edge of the sample had reached was measured one minute after opening the gate 1. Using the position of the gate 1 as a reference (0.0 cm), the distance traveled was measured in 0.5 cm increments.

Under the measurement conditions described above, the consistency of the pet food of the first embodiment is within a range from 9.0 to 16.0 cm/minute, and the water content is at least 80.0% by weight of the total weight of the pet food composition.

A pet food that satisfies these conditions is easy to eat, and both the palatability for pets and the eating completion rate (the rate at which all the food is eaten with no leftovers) improve.

There are no particular limitations on the consistency, provided it satisfies the range from 9.0 to 16.0 cm/minute, but from the viewpoint of improving the palatability for pets, the consistency is, in some embodiments, from 9.5 to 15.5 cm/minute, from 10.0 to 15.5 cm/minute, from 10.5 to 15.5 cm/minute, from 11.0 to 15.5 cm/minute, or from 11.5 to 15.0from 11.5 to 15.0 cm/minute. For specified ranges of solid component fill weight or of solid ingredient content, the following ranges of consistency are also preferred: 14.5 to 15.5 cm/minute; 11.0 to 12.0 cm/minute and & 9.0 to 9.5 cm/minute.

Although there are no particular limitations on the water content in the pet food of the first embodiment described above, provided that it is at least 80.0% by weight of the total weight of the pet food composition, from the viewpoints of improving the palatability for pets, and increasing the amount of water ingested by the pet, the water content is, in some embodiments, within a range from 84.0 to 90.0% by weight of the total weight of the pet food composition, from 85.0 to 89.5% by weight of the total weight of the pet food composition, or from 86.0 to 89.1% by weight of the total weight of the pet food composition.

### Second Embodiment

A pet food according to a second embodiment of the present description contains solid ingredients not passing through a sieve with an opening size of 710 μm, has a water content of at least 80.0% by weight of the total weight of the pet food composition, and has fluidity.

In this description, “having fluidity” refers to an amorphous substance, able to change its shape to the shape of its container, or having flow properties at the measuring conditions of a Bostwick consistometer described herein, and which container is also described herein. In the present invention, the substance having fluidity is a liquid, and is not a gas.

There are no particular limitations on sizes of the solid ingredients, provided that they do not pass through a mesh filter having a sieve with an opening size of 710 μm. From the viewpoints of improving the palatability and the eating completion rate (the rate at which all the food is eaten with no leftovers) by enhancing a degree of mixing of the solid ingredients with a liquid component or a paste-like component in the pet food, the solid ingredients have sizes, in some embodiments, passing through a sieve with an opening size of 10 mm, but not passing through a sieve with an opening size of 710 μm; the solid ingredients have sizes passing through a sieve with an opening size of 5 mm, but not passing through a sieve with an opening size of 710 μm; or the solid ingredients have sizes passing through a sieve with an opening size of 1 mm, but not passing through a sieve with an opening size of 710 μm.

The solid ingredients passing through a sieve with an opening size of 10 mm are sufficiently mixed with a liquid (soup-like) component or a paste-like component, and the solid ingredients themselves are also mixed with each other, thereby the palatability and the eating completion rate, in some embodiments, improved. The degree of intertwining is more enhanced as solid ingredients become smaller, and the palatability and the eating completion rate tend, in some embodiments, to be more improved. The lower limit of an opening size, which is 710 μm, in some embodiments, is changed within the range of 680 μm to 740 μm. When sizes of solid ingredients are equal to or greater than the lower limit, solid texture, which is not obtainable from mere liquid soup (pet food), is obtained, and thereby the palatability and the eating completion rate seem, in some embodiments, to be improved.

In this description, when the sizes of the solid ingredients are “not passing through a sieve with an opening size of 710 μm,” the solid ingredients have a diameter or a side longer than 710 μm. Similarly, when the sizes of the solid ingredients are “passing through a sieve with an opening size of 10 mm,” the longest diameter (distance across) of the solid ingredients is shorter than 10 mm.

To determine whether the solid ingredients pass through the sieve having the above-mentioned opening size or remain on the sieve, the pet food of the second embodiment is placed on the sieve, and after a predetermined time has passed, it is determined whether the solid ingredients pass through the sieve or remain on the sieve. The amount remaining on the sieve is the content of the solid ingredients. Usually, the solid ingredients contain water.

The above-mentioned predetermined time refers to the time after which any ingredients do not pass through the sieve by gravity, and usually 0.5 to 24 hours are sufficient for the predetermined time. Although there are no particular limitations on an area of the sieve, if the area is extremely small, clogging may occur. A sieve having an area sufficientsized to try to avoid clogging is, in some embodiments, used. When the above-mentioned pet food is placed on the sieve, usually it is suitably placed with a thickness of the pet food being about from 0.5 cm to 5.0 cm.

Although there are no particular limitations on the content of the solid ingredients (the amount remaining on the sieve) in the pet food of the second embodiment, from the viewpoints of improving the palatability and the eating completion rate, the content of the solid ingredients is, in some embodiments, within a range from 12.0% by weight of the total weight of the pet food composition or greater, from 12.0 to 23.0% by weight of the total weight of the pet food composition, from 12.5 to 21.0% by weight of the total weight of the pet food composition, from 13.0 to 20.0% by weight of the total weight of the pet food composition, or from 13.5 to 19.0% by weight of the total weight of the pet food composition. For specified ranges of consistency, the following ranges of solid ingredient content are also preferred: 12.0 to 20.0% by weight; 13.0 to 19.0% by weight; and 21.0 to 23.0% by weight.

Although there are no particular limitations on the fill weight (hereafter also abbreviated as simply “FW”) of solid components incorporated within the pet food of the first embodiment and the second embodiment, from the viewpoints of ensuring that the pet food contains adequate nutrition, and improving the palatability for pets, the FW is, in some embodiments, within a range from 10.0 to 18.0% by weight, from 10.5 to 16.0% by weight, from 10.5 to 14.0% by weight, from 11.0 to 15.0% by weight, from 11.0 to 14.0% by weight, from 12.0 to 14.0% by weight, from 12.0 to 13.7% by weight, or from 12.4 to 13.6% by weight. from 12.4 to 13.6% by weight. For specified ranges of consistency, the following ranges of solid component fill weight are also preferred: 11.0 to 13.0% by weight; 10.8 to 13.0% by weight; and 15.0 to 16.5% by weight (this range being for a consistency of 9.0 to 9.5 cm/minute).

In the present description, the fill weight (FW) refers to the percentage content (units: % by weight) of solid components incorporated per unit weight of the pet food. The expression “solid components” does not describe solid components having a specific shape (solid ingredients), but rather describes the solid components left when the water content is removed from the pet food by evaporation. In other words, FW represents the percentage of the total weight of the pet food represented by the weight of all of the solid components excluding the water content. Accordingly, the weight of the solid components is not limited to the weight of those ingredients included within the pet food as solid substances (solid ingredients), but also includes the weight of ingredients dissolved within liquids and ingredients that have been crushed into pastes. In other words, there are no particular limitations on the shape or state of the ingredients included within the pet food of the first embodiment, and ingredients of any shape, and ingredients in any state such as liquids, solids, gels and fibers, are, in some embodiments, added.

Although there are no particular limitations on a consistency of the pet food of the second embodiment, it is, in some embodiments, from 9.0 to 16.0 cm/minute as measured using a Bostwick consistometer. A pet food that satisfies this condition is easy to eat, and both the palatability for pets and the eating completion rate is improvable.

There are no particular limitations on the consistency of the pet food of the second embodiment, although it is preferably in the range from 9.0 to 16.0 cm/minute. From the viewpoint of improving the palatability for pets, the consistency is, in some embodiments, from 9.5 to 15.5 cm/minute, from 10.0 to 15.5 cm/minute, from 10.5 to 15.5 cm/minute, from 11.0 to 15.5 cm/minute, or from 11.5 to 15.0 cm/minute.from 11.5 to 15.0 cm/minute. For specified ranges of solid component fill weight or of solid ingredient content, the following ranges of consistency are also preferred: 14.5 to 15.5 cm/minute; 11.0 to 12.0 cm/minute and & 9.0 to 9.5 cm/minute.

Although there are no particular limitations on the water content in the pet food of the second embodiment described above, provided that it is at least 80.0% by weight of the total weight of the pet food composition, from the viewpoints of improving the palatability for pets, and increasing the amount of water ingested by the pet, the water content is, in some embodiments, within a range from 84.0 to 90.0% by weight of the total weight of the pet food composition, from 85.0 to 89.5% by weight of the total weight of the pet food composition, or from 86.0 to 89.0% by weight of the total weight of the pet food composition.

There are no particular limitations on the ingredients for the pet food of the first embodiment, provided they are ingredients capable of realizing the aforementioned consistency and water content, and the types of ingredients typically used as a complete source of nutrition for pet food are, in some embodiments, used. Also, there are no particular limitations on the ingredients for the pet food of the second embodiment, provided they are ingredients capable of realizing the aforementioned sizes of the solid components and water content, and the types of ingredients typically used as a complete source of nutrition for pet food are, in some embodiments, used. These ingredients include not only protein components, but also include added carbohydrate components, vitamins, minerals, salts, fats, oils and animal food extracts and the like.

### <<Pet Food Composition>>

The pet food of the first embodiment and the second embodiment is, in some embodiments, manufactured by using the pet food composition of the first embodiment. The pet food composition of the first embodiment contains protein components and water.

### <Protein Component>

The protein components contained in the pet food composition of the first embodiment are, in some embodiments, components of macromolecular compounds, which are made from a number of L-amino acids linked together like a chain. Examples of protein components contained in the pet food composition of the first embodiment include fish such as tuna, sardines and bonito (fish-derived components), or domestic animal ingredients such as beef, pork or chicken.

Since protein components are contained in the pet food composition of the first embodiment, when pets eat the pet food, nutrients for supporting their bodies can be taken.

The protein components contained in the pet food composition of the first embodiment are, in some embodiments, equal to or greater than 50% by weight of solid components excluding the water content (FW) or within a range from 50 to 99% by weight of solid components excluding the water content (ie the FW). When protein components are within the range described above, the nutritional value of the pet food made by using the pet food composition of the first embodiment is improvable.

### <Fish-Derived Component>

There are no particular limitations on protein components contained in the pet food composition of the first embodiment, provided that they are nutrients for supporting bodies of pets fish-derived components are, in some embodiments, contained in the protein components.

Fish-derived components are the components made into a given shape using processed fish such as tuna, sardines and bonito. Fish-derived components are, in some embodiments, tuna, sardines and bonito, and, in some embodiments, tuna.

When fish-derived components are contained in the protein components, the palatability for cats among pets is, in some embodiments, particularly improved.

The fish-derived components are, in some embodiments, equal to or greater than 50% by weight of FW, or within a range from 50 to 99% by weight of FW. When fish-derived components are within the above-mentioned range, the palatability for cats is improvable.

### <Thickener>

The pet food composition of the first embodiment of the present description, in some embodiments, contains a thickener. Examples of the thickener include polysaccharides such as guar gum, starch, carrageenan, xanthan gum, and locust bean gum. Among them, guar gum is, in some embodiments, a component of the thickener.

When a thickener is contained in the pet food composition, a consistency of the pet food is, in some embodiments, altered to be easy to eat by one or more pets.

A thickener contained in the pet food composition of the first embodiment is, in some embodiments, within a range from 0.05 to 3.0% by weight of the total weight of the pet food composition.

### <Other Component>

The pet food composition of the first embodiment of the present description, in some embodiments, contains carbohydrate components, vitamins, minerals, salts, fats, oils and animal food extracts and the like. Among these other components, animal food extracts are, in some embodiments, contained in the pet food composition.

Examples of carbohydrate components include wheat, rice, corn and the like. Examples of vitamins include vitamin A, B1, B2, B6, B12, D, E, and K; choline, niacin, pantothenic acid, biotin, folic acid and the like. Examples of minerals include Ca, Cl, Cu, Fe, I, K, Mg, Mn, Na, Se, Zn and the like. Examples of salts include sodium chloride, potassium chloride and the like. Examples of fats include chicken fat, beef fat, lard and the like. Examples of oils include soybean oil, fish oil and the like.

Examples of animal food extracts include fish extract, chicken extract, pork extract and the like.

When other components are contained in the pet food, a nutritional balance of the pet food composition becomes good.

Water contained in the pet food composition of the first embodiment and the second component is, in some embodiments, added directly, or is, in some embodiments, derived from water contained in the protein components, the thickener and the like.

Water contained in the pet food composition of the first embodiment or the second embodiment is equal to or greater than 80.0% by weight of the total weight of the pet food composition. The water is contained, in some embodiments, within a range from 84.0 to 90.0% by weight of the total weight of the pet food composition, from 85.0 to 89.5% by weight of the total weight of the pet food composition, or from 86.0 to 89.1% by weight of the total weight of the pet food composition. When water contained in the pet food composition is within the above-mentioned range, the palatability for cats is improvable, and the amount of water ingested by the pet is increasable.

### <<Method of Manufacturing Pet Food>>

There are no particular limitations on the method used for manufacturing the pet food of the first embodiment and the second embodiment, and in the method for manufacturing the pet food of the first embodiment and the second embodiment, the pet food composition of the first embodiment is, in some embodiments or the second embodiment is mixed, treated by employing a mincer, and treated by employing a mixer. Also, for example, a thickener is, in some embodiments, added as an ingredient to adjust the consistency.

Examples of the thickener include, e.g., polysaccharides such as guar gum, starch, carrageenan, xanthan gum, and locust bean gum.

In those cases where the protein components included in the ingredients of the pet food of the first embodiment and the second embodiment include fish such as tuna, sardines and bonito, or domestic animal ingredients such as beef, pork or chicken, these ingredients are, in some embodiments, heated or cooked in advance using conventional methods.

From the viewpoint of enhancing the nutritional value of the pet food of the first embodiment and the second embodiment, an ingredient formulation is, in some embodiments, employed in which at least 50% by weight of the total weight of the solid components (FW), or from 50 to 99% by weight of the total weight of solid components (FW) upon removal of the water content from the pet food is composed of protein components. Further, a formulation in which at least 50% by weight, or from 50 to 99% by weight, of the FW is composed of fish-derived components is, in some embodiments, also used. By using these types of formulations, the palatability for cats is improvable.

In order to inform pet owners that the pet food of the first embodiment and the second embodiment is a pet food particularly suitable for cats, when the pet food of the first embodiment or the second embodiment is packaged and placed on sale, the pet food is, in some embodiments, sold with a label indicating that the pet food is suitable for cats displayed appropriately on the packaging.

The pet food of the first embodiment and the second embodiment is, in some embodiments, manufactured, for example, by mixing the protein components and water, and then adding a thickener as required. There are no particular limitations on the mixing method used, and conventional methods employing a mixer or a mincer are, in some embodiments, employed, but a method that enables uniform mixing is useable. In the method for manufacturing the pet food of the first embodiment and the second embodiment, a mincer treatment and a mixer treatment are, in some embodiments, combined. In the mincer treatment, a mesh having a mesh size of 5 to 11 mm is, in some embodiments, used, a mesh having a mesh size of 6 to 10 mm is, in some embodiments, used, or a mesh having a mesh size of 7 to 9 mm is, in some embodiments, used. Also, the number of rotations for the mixer treatment is, in some embodiments, from 60 to 110 rpm, or from 70 to 100 rpm, or from 80 to 90 rpm. Time for the mixer treatment is, in some embodiments, for 3 to 7 minutes or for 4 to 6 minutes. By mixing (processing) the protein components in advance to achieve a mince-like state, and then mixing this minced protein ingredient with the other ingredients, the ingredients is mixable together more uniformly. Following mixing, the pet food may exist in a paste-like form. Further, lumps of (solid) ingredients (the solid ingredients described above) are, in some embodiments, dispersed within the paste-like pet food. By ensuring that the ingredients of the pet food are mixed uniformly, or by ensuring that the pet food is in a paste-like form, pets are, in some embodiments, discouraged from eating only a portion of the pet food described above, or eating only a portion of the ingredients, and the eating completion rate is improvable.

In this description, “in a paste-like form” refers to a state which at least has fluidity, and has a consistency (static viscosity) higher than water. For example, the aforementioned consistency is a state of 9.0 to 16.0 cm/minute when measured using a Bostwick consistometer. When a portion of the pet food of the second embodiment is in a paste-like form, the paste-like portion (component) may contain ultrafine solid ingredients passing through a sieve with an opening size of 710 μm.

The time for which the ingredients are mixed, and the temperature at which mixing is performed are set as appropriate. By adjusting the mixing time, the consistency of the pet food is, in some embodiments, regulated. Further, by altering the amount of water added during mixing, the sizes of the aforementioned solid ingredients, and the consistency and the water content of the pet food can be regulated. The consistency of the pet food can also be regulated by altering the amount of the thickener. Furthermore, the FW is, in some embodiments, regulated by altering the weight of materials containing a solid component relative to the total weight of all the materials that constitute the pet food.

The pet food of the first embodiment and the second embodiment usually does not separate into solid ingredients and a liquid soup, but the pet food of the first embodiment rather exists in a state composed of only a paste-like component having the specified consistency and water content described above, or a state in which such a paste-like component is mixed with solid ingredients. The pet food of the second embodiment is, in some embodiments, in a state in which a paste-like component having the water content described above is mixed with solid ingredients. If the pet food were to exist in a state in which the soup and solid ingredients separated, then there is a high probability that only the soup will be eaten and the solid ingredients will be left uneaten. Moreover, the same problem can occur even in pet foods composed of a jelly-like (gelled) soup and solid ingredients, which are prepared by adding gelatin to solidify the soup. In other words, because the jelly-like soup and the solid ingredients are essentially separate, there is a high probability that only the jelly-like soup will be eaten and the solid ingredients will be left uneaten.

In response to this type of problem, the pet food of the first embodiment is, in some embodiments, in a state that is not separated into a soup component and solid ingredients, but is rather composed of a paste-like state (component) having the specified consistency and water content mentioned above within at least a portion of the pet food. The pet food may also include solid ingredients in addition to the aforementioned paste-like component. In this case, because the solid ingredients are mixed with the paste-like component, the solid ingredients are carried into the mouth of the pet together with the paste-like component. As a result, the eating completion rate for the pet food of the first embodiment is improvable.

Furthermore, the pet food of the second embodiment, in some embodiments, does not separate into a soup component and solid ingredients, but rather has a paste-like form (component) having the water content described above at least in a portion of the pet food. In some embodiments, the consistency of the pet food including a paste-like form described above is the specified consistency described above. By having such a paste-like component, the solid ingredients are mixed with the paste-like component, and the solid ingredients are carried into the mouth of the pet together with the paste-like component. As a result, the eating completion rate for the pet food of the second embodiment is improvable. The paste-like component described above may contain components in which a portion of ingredients is crushed or dissolved.

The pet food of the first embodiment and the second embodiment, in some embodiments, is stored under vacuum in a sealed container. In this case, the pet food is, e.g., stored in a pouch container that has undergone the type of pouch processing (lamination) employed in the preparation of conventional food using a retort, and the like. The amount of the pet food stored inside the container is, in some embodiments, kept small so that single meal portions are stored in individual containers, or a larger amount of pet food (for example, food for three meals) are stored in a container of larger volume. Further, from the viewpoint of enabling long-term storage, a sterilization treatment, in some embodiments, is performed by a conventional heat treatment or pressure treatment following filling of the pouch container with the pet food.

Although the pet food of the second embodiment is, in some embodiments, stored in a metal can or a plastic cup container, it is, in some embodiments, stored under vacuum in the pouch container described above. Since the pouch container is a flexible container, the pet food of the second embodiment can easily be taken out of the container. In this case, by wringing (squeezing) the pouch container to take the pet food out of the container, solid ingredients composing the pet food of the second embodiment are encouraged to exit from the container. The solid ingredients described above have relatively small shapes, which solid ingredients are difficulttroublesome to remove from can or cup containersthey there. This problem is solvable by using a pouch container. Usually, when pet foods in cans or cup containers are given to pets, the pets cannot easily eat the pet foods from the narrow mouths of the containers, this thus resulting in leftovers. Accordingly, it is useful that pet foods are easily taken out from containers. In addition, it is also useful that containers are easily discarded after pet foods are taken out, and the pouch container is easily discarded because of its small size.

The pet food of the first embodiment is eaten by choice by all non-plant-eating animals, and is liked by cats and dogs, and particularly liked by cats.

In the present description and the claims, the term “pet” describes an animal that is raised by people. In a more strict definition, a pet is an animal that is cherished by its owner. Further, “pet food” is food for a pet. The pet food is, in some embodiments, sold as “animal feed”.

### EXAMPLES

The present invention is described below in further detail using a series of examples, but the present invention is in no way limited by the following examples. In the following description, “%” refers to “% by weight” of the total weight of the pet food composition.

### [Manufacture of Pet Food A]

Using the blend ratios shown in Table 1, tuna, a thickener containing guar gum, an animal extract and water were mixed together, and treated by employing a mincer with a mesh having a mesh size of 8 mm After that, a mixer was used to crush and uniformly mix the ingredients at 85 rpm for 5 minutes to manufacture a pet food of each of a series of test examples. The consistency, FW and water content of each pet food are shown in Table 1.

In Table 1, the consistency describes the value measured using a Bostwick consistometer as described above (a suitable Bostwick consistometer has model number: CSC 24925-000 and is manufactured by CSC Scientific Company, Inc., Virginia, USA), under the conditions described above (units: cm/minute). FW is the amount represented by formula (1) shown below.

FW=(weight of solid components obtained upon evaporation of the water content from the pet food)/(initial weight of the pet food)×100(%) (1)

Further, the water content of the pet food is 100-FW (%).

Measurement of the water content and the FW was performed using a constant temperature dryer (model number: DS400, manufactured by Yamato Scientific Co., Ltd., Tokyo, Japan.) as described above.

### [Manufacture of Comparative Example A]

A pet food of Comparative Example A1 was manufactured as follows. Comparative Example A1 is a non-fluid jelly (solid), and therefore the consistency was 0 cm/minute.

First, the size of a tuna ingredient was adjusted to obtain flakes of 5 to 10 mm, and these flakes were then mixed with a thickener to obtain a solid ingredient. Next, water, a thickener, an animal extract and corn starch were mixed together to obtain a jelly thickener. Subsequently, a pouch container was filled with the solid ingredient and the jelly thickener, the pouch was sealed, and heat, pressure and sterilization treatments were performed.

The blend ratio of Comparative Example A1 is shown in Table 1. Palatability of Comparative Example A1 were not measured, and are therefore not shown in the table.

TABLE 1

| | | | Water + | | | | Water | | |
|---|---|---|---|---|---|---|---|---|---|
| | Tuna | Thickener | extract | TOTAL | Consistency | FW | content | | |
| | (%) | (%) | (%) | (%) | (cm/min) | (%) | (%) | Palatability | |
| Test example | 30 | 2.77 | 67.23 | 100 | 9.0 | 12.0 | 88.0 | 53:47 | B |
| A1 | | | | | | | | | |
| Test Example | 25 | 2.77 | 72.23 | 100 | 11.5 | 10.5 | 89.5 | 54:46 | B |
| A2 | | | | | | | | | |
| Test Example | 30 | 2.08 | 67.92 | 100 | 11.5 | 12.4 | 87.6 | 62:38 | A |
| A3 | | | | | | | | | |
| Test Example | 35 | 0.93 | 64.07 | 100 | 11.5 | 13.6 | 86.4 | 69:31 | A |
| A4 | | | | | | | | | |
| Test Example | 20 | 2.83 | 77.17 | 100 | 15.0 | 10.2 | 89.8 | 39:61 | C |
| AS | | | | | | | | | |
| Test Example | 25 | 2.00 | 73.00 | 100 | 15.0 | 10.9 | 89.1 | 62:38 | A |
| A6 | | | | | | | | | |
| Test Example | 30 | 1.39 | 68.61 | 100 | 15.0 | 12.4 | 87.6 | 69:31 | A |
| A7 | | | | | | | | | |
| Test Example | 35 | 0.46 | 64.54 | 100 | 15.0 | 12.9 | 87.1 | 61:39 | A |
| A8 | | | | | | | | | |
| Test Example | 40 | 0.06 | 59.94 | 100 | 15.0 | 15.9 | 84.1 | 51:49 | B |
| A9 | | | | | | | | | |
| Test Example | 25 | 1.20 | 73.80 | 100 | 17.0 | 10.7 | 89.3 | 56:44 | B |
| A10 | | | | | | | | | |
| Test Example | 30 | 0.93 | 69.07 | 100 | 17.0 | 12.5 | 87.5 | 60:40 | B |
| A11 | | | | | | | | | |
| Test Example | 35 | 0.06 | 64.94 | 100 | 17.0 | 13.1 | 86.9 | 30:70 | C |
| A12 | | | | | | | | | |
| Test Example | 30 | 0.69 | 69.31 | 100 | 19.0 | 12.3 | 87.7 | 55:45 | B |
| A13 | | | | | | | | | |
| Comparative | 50 | 0.74 | 49.26 | 100 | 0 | 18.2 | 81.8 | | |
| Example A1 | | | | | | | | | |

### [Evaluation of Palatability]

The palatability for cats of each of manufactured pet foods was evaluated using the method described below. The resulting palatability was given a score of A to C as shown in Table 1. These scores are based on a numerical value which was calculated using the following method.

Taking the notation “numerical value X: numerical value B”,Y″, the numerical value X indicates the level (degree) of palatability for that particular test example, and the numerical value Y represents the level (degree) of palatability for the comparative example. Numerical value X+numerical value Y=100. When the numerical value X was 61 or higher, the palatability of the test example was evaluated as high (A). When the numerical value X was at least 50 but less than 61, the palatability of the test example was evaluated as being similar to that of comparative products (B). When the numerical value X was less than 50, the palatability of the test example was evaluated as being inferior to that of comparative products (C).

The method used for evaluating the palatability was as follows.

First, each of Test Examples A1 to A13 was paired with the comparative example to prepare a total of 13 pairs of pet foods. Each pair was tested over two days by monitoring 20 cats.

On the first day, each cat was provided with 40 g of each of the pair of pet foods, with the first pet food supplied from the left and the second pet food supplied from the right, and the amount of each pet food eaten by the cat was measured after one hour.

Based on the total weight of pet food consumed by the cat on the first day, the amount consumed of the pet food of the test example and the amount consumed of the pet food of the comparative example were determined as percentages. The percentages obtained for the 20 cats being monitored were averaged to obtain the first day results.

On the second day, each cat was provided with 40 g of each of the pair of pet foods, with the first pet food supplied from the right and the second pet food supplied from the left, and the amount of each pet food eaten by the cat was measured after one hour.

Based on the total weight of pet food consumed by the cat on the second day, the amount consumed of the pet food of the test example and the amount consumed of the pet food of the comparative example were determined as percentages. The percentages obtained for the 20 cats being monitored were averaged to obtain the second day results.

Finally, the results for the first day and the second day were averaged, and the consumption ratio that represents the final result (palatability) was determined A higher numerical value for this palatability indicates greater consumption by choice by the monitored cats.

### [Evaluation of Eating Completion Rate]

The eating completion rate was also evaluated in combination with the evaluation of the palatability. In the test described above, the eating completion rate was determined using formula (2) shown below.

Eating completion rate=(number of times the pet food was eaten completely)/(number of times the pet food was provided)×100 (2)

The results revealed that the eating completion rate for those test examples exhibiting a high degree of palatability tended to be higher than the eating completion rate for Comparative Example A1.

Based on the above results, it was found that Test Examples A1 to A4, A6 to A11, and A13 had palatability that was equal to or better than that of the comparative example, and also exhibited improved eating completion rates, indicating that these pet foods were superior to the comparative example.

Further, in Test Examples 3 and 4, in which the consistency was 11.5 cm/minute, and the FW was from 12.4 to 13.6% by weight, the palatability improved significantly. These results indicate that in those cases where the consistency is from 11.0 to 12.0 cm/minute, and the solid component fill weight is from 12.0 to 14.0% by weight, the palatability is improved even further.

Furthermore, in Test Examples A6 to A8, in which the consistency was 15.0 cm/minute, and the FW was from 10.9 to 12.9% by weight, the palatability improved significantly. These results indicate that in those cases where the consistency is from 14.5 to 15.5 cm/minute, and the solid component fill weight is from 10.5 to 13.0% by weight, the palatability is improved even further.

### [Manufacture of Pet Food B]

Using the blend ratios shown in Table 2, tuna, a thickener containing guar gum, an animal extract and water were ground by employing a grinder, and mixed together, and then treated by employing a mincer with a mesh having a mesh size of 8 mm. After that, a mixer was used to uniformly mix the ingredients at 85 rpm for 5 minutes to manufacture a pet food of each of a series of test examples. The content of the solid ingredient 1, consistency, FW and water content of each pet food are shown in Table 2.

In Table 2, Solid ingredient 1 refers to the content (units: % by weight) of solid ingredients that pass through a filter with an opening size of 1 mm, but do not pass through a filter with an opening size of 710 μm. The size of each solid ingredient represents the size of when the solid ingredient is included in a pet food.

In Table 2, the consistency, water content, and FW are measured by the same method described above.

### [Manufacture of Comparative Example B]

A pet food of Comparative Example B1 was manufactured in the same manner as for Comparative Example A1.

The blend ratio, content of solid ingredient 1, consistency, FW, and water content of Comparative Example B1 is shown in Table 2. The palatability of Comparative Example B1 were not measured, and therefore are not shown in the table.

TABLE 2

| | | | Water + | | | Solid | | Water | | |
|---|---|---|---|---|---|---|---|---|---|---|
| | Tuna | Thickener | extract | TOTAL | Consistency | ingredient | FW | content | | |
| | (%) | (%) | (%) | (%) | (cm/min) | 1 | (%) | (%) | Palatability | |
| Test example | 30 | 2.8 | 67.2 | 100 | 9.0 | 14.0 | 11.8 | 88.2 | 53:47 | B |
| B1 | | | | | | | | | | |
| Test Example | 35 | 0.6 | 64.4 | 100 | 9.0 | 18.0 | 13.2 | 86.8 | 45:55 | C |
| B2 | | | | | | | | | | |
| Test Example | 40 | 0.2 | 59.8 | 100 | 9.0 | 21.9 | 15.8 | 84.2 | 73:27 | A |
| B3 | | | | | | | | | | |
| Test Example | 25 | 2.8 | 72.2 | 100 | 11.5 | 12.7 | 10.8 | 89.2 | 54:46 | B |
| B4 | | | | | | | | | | |
| Test Example | 30 | 2.1 | 67.9 | 100 | 11.5 | 13.6 | 12.0 | 88.0 | 62:38 | A |
| B5 | | | | | | | | | | |
| Test Example | 35 | 0.9 | 64.1 | 100 | 11.5 | 18.6 | 13.7 | 86.3 | 69:31 | A |
| B6 | | | | | | | | | | |
| Test Example | 40 | 0.2 | 59.8 | 100 | 11.5 | 20.4 | 15.5 | 84.5 | 60:40 | B |
| B7 | | | | | | | | | | |
| Test Example | 20 | 2.8 | 77.2 | 100 | 15.0 | 11.5 | 9.7 | 90.3 | 39:61 | C |
| B8 | | | | | | | | | | |
| Test Example | 25 | 2.0 | 73.0 | 100 | 15.0 | 12.8 | 11.1 | 88.9 | 62:38 | A |
| B9 | | | | | | | | | | |
| Test Example | 30 | 1.4 | 68.6 | 100 | 15.0 | 13.7 | 12.7 | 87.3 | 69:31 | A |
| B10 | | | | | | | | | | |
| Test Example | 35 | 0.5 | 64.5 | 100 | 15.0 | 18.0 | 12.6 | 87.4 | 61:39 | A |
| B11 | | | | | | | | | | |
| Test Example | 40 | 0.1 | 59.9 | 100 | 15.0 | 21.3 | 15.8 | 84.2 | 51:49 | B |
| B12 | | | | | | | | | | |
| Test Example | 25 | 1.2 | 73.8 | 100 | 17.0 | 13.6 | 10.7 | 89.3 | 56:44 | B |
| B13 | | | | | | | | | | |
| Test Example | 30 | 0.9 | 69.1 | 100 | 17.0 | 15.8 | 12.9 | 87.1 | 60:40 | B |
| B14 | | | | | | | | | | |
| Test Example | 35 | 0.1 | 64.9 | 100 | 17.0 | 16.9 | 13.1 | 86.9 | 30:70 | C |
| B15 | | | | | | | | | | |
| Test Example | 30 | 0.7 | 69.3 | 100 | 19.0 | 13.4 | 12.3 | 87.7 | 55:45 | B |
| B16 | | | | | | | | | | |
| Comparative | 50 | 0.7 | 49.3 | 100 | 0 | 100 | 18.2 | 81.8 | | |
| Example B1 | | | | | | | | | | |

### [Evaluation of Palatability]

The palatability for cats of each of manufactured pet foods was evaluated using the same method described above.

### [Evaluation of Eating Completion Rate]

The eating completion rate was evaluated using the same method described above.

The results revealed that the eating completion rate for those test examples exhibiting a high degree of palatability tended to be higher than the eating completion rate for Comparative Example B 1.

Based on the above results, it was found that Test Examples B1, B3 to B7, B9 to B 14, and B 16 had palatability that was equal to or better than that of the comparative example, and also exhibited improved eating completion rates, indicating that these pet foods were superior to the comparative example.

Further, in Test Example B3, in which the consistency was 9.0 cm/minute, and the FW was from 15.8% by weight, the palatability improved significantly. These results indicate that in those cases where the consistency is from 9.0 to 9.5 cm/minute, and the solid component fill weight is from 15.0 to 16.5% by weight, the palatability is improved even further.

Further, in Test Examples B5 and B6, in which the consistency was 11.5 cm/minute, and the FW was from 12.0 to 13.7% by weight, the palatability improved significantly. These results indicate that in those cases where the consistency is from 11.0 to 12.0 cm/minute, and the solid component fill weight is from 12.0 to 14.0% by weight, the palatability is improved even further.

Furthermore, in Test Examples B9 to B11, in which the consistency was 15.0 cm/minute, and the FW was from 11.1 to 12.7% by weight, the palatability improved significantly. These results indicate that in those cases where the consistency is from 14.5 to 15.5 cm/minute, and the solid component fill weight is from 10.8 to 13.0% by weight, the palatability is improved even further.

Also, Table 2 indicates the following.

In Test Example B3, in which the consistency was 9.0 cm/minute, and the content of solid ingredient 1 was from 21.9% by weight, the palatability improved significantly. These results indicate that in those cases where the consistency is from 9.0 to 9.5 cm/minute, and the content of solid ingredient 1 is from 21.0 to 23.0% by weight, the palatability is improved even further.

Further, in Test Examples B5 and B6, in which the consistency was 11.5 cm/minute, and the content of solid ingredient 1 was 13.6 or 18.6% by weight, the palatability improved significantly. These results indicate that in those cases where the consistency is from 11.0 to 12.0 cm/minute, and the content of solid ingredient 1 is from 13.0 to 19.0% by weight, the palatability is improved even further.

Furthermore, in Test Examples B9 to B11, in which the consistency was 15.0 cm/minute, and the content of solid ingredient 1 was from 12.8, 13.7, or 18.0% by weight, the palatability improved significantly. These results indicate that in those cases where the consistency is from 14.5 to 15.5 cm/minute, and the content of solid ingredient 1 is from 12.0 to 20.0% by weight, the palatability is improved even further.

Each of the formulations and combinations described in the above embodiments are merely examples, and additions, omissions, substitutions, and other modifications can be made without departing from the spirit or scope of the present invention. Accordingly, the present invention is not to be considered as being limited by the above embodiments, and is only limited by the scope of the claims.

### INDUSTRIAL APPLICABILITY

The pet food according to the present description is usable widely in the field of food for pet animals, and is therefore very useful industrially.

### DESCRIPTION OF THE REFERENCE SIGNS

1: Gate
2: Upstream section
3: Lever
4: Downstream section
5: Height adjustment screw
6: Opening

1. A pet food, having a consistency measured using a Bostwick consistometer of 9.0 to 16.0 cm/minute, and having a water content of at least 80.0% by weight of the total weight of the pet food composition.

2. The pet food according to claim 1, wherein a solid component fill weight is within a range from 10.5 to 14.0% by weight.

3. The pet food according to claim 1, wherein the consistency is from 14.5 to 15.5 cm/minute, and a solid component fill weight is from 11.0 to 13.0% by weight.

4. A pet food containing solid ingredients not passing through a sieve with an opening size of 710 μm, having a water content of at least 80.0% by weight of the total weight of the pet food composition, and having fluidity.

5. The pet food according to claim 4, wherein the solid ingredients have sizes passing through a sieve with an opening size of 10 mm.

6. The pet food according to claim 4, wherein a content of the solid ingredients is at least 12.0% by weight of the total weight of the pet food composition.

7. The pet food according to claim 4, having a consistency measured using a Bostwick consistometer of 14.5 to 15.5 cm/minute, wherein a content of the solid ingredients is within a range from 12.0 to 20.0% by weight of the total weight of the pet food composition.

8. The pet food according to claim 4, having a consistency measured using a Bostwick consistometer of 11.0 to 12.0 cm/minute, wherein a content of the solid ingredients is within a range from 13.0 to 19.0% by weight of the total weight of the pet food composition.

9. The pet food according to claim 4, having a consistency measured using a Bostwick consistometer of 9.0 to 9.5 cm/minute, wherein a content of the solid ingredients is within a range from 21.0 to 23.0% by weight.

10. The pet food according to claim 4, wherein the solid component fill weight is within a range from 10.5 to 14.0% by weight.

11. The pet food according to claim 4, having a consistency measured using a Bostwick consistometer of 14.5 to 15.5 cm/minute, wherein the solid component fill weight is within a range from 10.8 to 13.0% by weight.

12. The pet food according to claim 1, wherein the consistency is from 11.0 to 12.0 cm/minute, and a solid component fill weight is from 12.0 to 14.0% by weight.

13. The pet food according to claim 1, further comprising a thickener.

14. The pet food according to claim 1, wherein the pet food is in a paste form.

15. The pet food according to claim 4, wherein at least 50% by weight of solid ingredients are derived from fish.

16. The pet food according to claim 1, wherein at least 50% by weight of a solid component is derived from fish.

17. The pet food according to claim 13, wherein the thickener is guar gum.

18. The pet food according to claim 1, wherein the pet food is a food for cats.

19. The pet food according to claim 1, wherein the pet food is packed inside a pouch container.
